(19) United States
(12) Patent Application Publication
(10) Pub. No.: US 2016/0101850 A1
(43) Pub. Date: Apr. 14, 2016

(54) Multi-rotor frame structure

(71) Applicant: Che Min LIN, New Taipei City (TW)

(72) Inventor: Che Min LIN, New Taipei City (TW)

(21) Appl. No.: 14/873,217

(22) Filed: Oct. 2, 2015

(30) Foreign Application Priority Data
Oct. 13, 2014 (TW) 103218078

(51) Int. Cl. B64C 27/08; B64C 39/02; B64C 1/06

(52) U.S. Cl. CPC B64C 27/08; B64C 1/061; B64C 39/024; B64C 2201/126; B64C 2201/024

(57) ABSTRACT

This invention relates to a multi-rotor aircraft frame structure, which is mainly the use of stainless steel tubes and engineering plastics has the rigidity and toughness, directly to the stainless steel tubes symmetrical inserted nailed in plastic sheet to constitute the main frame structure, and by connecting plurality support blocks and plurality support rods to construct a kind of peripheral support structure to obtain sufficient structural strength, thereby to constructing a light weight and low cost and practicality high-performance multi-rotor aircraft frame.

### FIELD OF THE INVENTION

The present invention relates to a multi-rotor frame structure, especially in the form of a skeletal structure composed multi-rotor aircraft frame structure, it is a remote-controlled model aircraft that can vertically take off and land, which is composed of multiple sets of electrically driven propeller push to generate lift flight, and by controlling the relative different propeller thrust to change their relative rotational speed and torque to control multi-rotor aircraft flight path. If the vehicle is driven by four propellers can say that this is a Quad-rotor, if the six groups propeller to drive can be referred to as a Hex-rotor. Today, multi-rotor aircraft is common to have four-axis and six-axis and other types, since VTOL flight, so its wide range of applications, from leisure and entertainment use to aerial reconnaissance and other purposes more development, but because of it is through the remote way to remote control flight, so often due to operator disoriented error operating or malfunction crashed cause losses, but the expensive multi-rotor aircraft, its maintenance costs nor cheap, so there is the need to be improved the purpose of the present invention is to provide a relatively cheap and common material which is economical and practical effect of frame body structure, which can reduce the cost and the maintenance costs of the multi-rotor aircraft.

Multi-rotor aircraft, mostly their frame body composition comprises a multi-rotor frame and several motor power group (by the motor and the E S C and propeller composition) and flight control board plus wireless remote control receiver and battery and other components, the overall structure is very simple.

Weight, in the designing and manufacturing of the aircraft must be one of the priority project, the effectiveness performance of multi-rotor aircraft flight is inversely proportional to its weight, the lighter the weight the better effectiveness will be its performance, and vice versa. In multi-rotor aircraft, its a battery electric driving motor to produce thrust to flight, if the body weight heavier, the required thrust will be larger, its current consumption will be more, and vice versa, therefore, if the capacity of a fixed batteries, lightweight frame body which would be more long-term flight endurance, heavier frame body will be shorter its endurance, and therefore at the time of designing and manufacturing of multi-rotor aircraft components, more will designer try to try to reduce its weight to improve the aircraft's flight performance.

### BACKGROUND OF THE INVENTION

As described above, a multi-rotor aircraft composition may include a frame and a number of motor power group and the flight control board plus wireless remote control receiver and batteries and other components, most of which have been for the industrial production of products and has their own specifications and most are in the form of components and parts supply the market, which allows the user to follow the specifications they need to assemble an multi-rotor aircraft, and among these components, the largest and most important component is a multi-rotor frame, the frame structure composed of material informality, most are now using carbon fiber or glass fiber or aluminum plastic wood and other lightweight materials to produce kits supply the market.

To constitute a frame, mostly by combine two pieces of sheet fiber plate as the main body, on which arranged symmetry branched tubular motor arms, each motor arm fixed by aluminum clamp seat (or plastic clamp seat) for clamping each tubular motor arm by screw locks, plus the landing gear to form a multi-rotor aircraft frame. The Quad-rotor frame has four motor arm can be locked four electric motors, Hex-rotor frame have six branch arms configuration, motor arm common are round tubular and square tubular and other types of motor arm, wherein the square tube constituted mostly by the aluminum, round tube may be carbon fiber or glass fiber or aluminum and other materials constitute. Both ends of the aluminum square tube arm can directly open screw holes and screw lock the main body respectively and mount the motor, but aluminum quality is relatively soft, have considerable arm strength necessary, so to be have considerable caliber and wall thickness, its weight will also increase, carbon fiber or fiberglass arms mostly tube shape, the quality is light also hard, arm strength is better, but its texture is also brittle, it cannot be directly in the tube body lock screw, so mostly by the tube clamp bases and motor seat and other components to combine each motor arm lock the main body and motor by screws.

The size of multi-rotor aircraft frame is referring to the diagonal length in millimeters from each motor center, the diagonal length from motor center to motor center is about 450 mm to be a 450-class frame, or 600 mm length to be a 600-class frame.

As described above, under the consideration reducing weight, designer mostly using lighter materials for the relatively simple structural design, hoping to made a light-weight frame to enhance the effectiveness of the aircraft, so multi-rotor aircraft frame structure very simple, but with a simple frame structure to reduce the use of constituent materials, it must require the quality of materials used to meet the needs of the strength of the structures, so it cannot be less material, it is necessary to enlarge structural components size to obtain better structural strength, this can be seen from a simple frame structure to achieve weight loss results will be limited.

In the above materials that can constitute a frame, the carbon fiber is the most expensive materials, glass fiber and aluminum is much cheaper, by the aluminum tube and the glass fiber plate assembly combined to form a frame will be a more economical way, but whether it is by what material constituted, maintenance costs generated by its future will not be cheap, the reason is that, a simple structure constituted frame, after (lost controlled) the high-speed collision onto the ground, the result usually only be worthy of use or breakage may be, if it is damaged it will not damage the extent of respectively large and small, all damaged parts must be replaced, it will be another sum spent.

After losing control, aircraft usually do not fall to the ground by a horizontal posture, so that when the multi-rotor aircraft to fall to the ground, almost all will be by the motor arm first contact to the ground and withstand the force of impact (propeller except), the example of structure of current implementations of multi-rotor frame, the majority fix the motor arms by locking screws, directly fixed onto the main body, so its structure contact points to withstand direct impact of stress, this stress also will conducted by the motor arms to the main body, the frame body may therefore result damaged leaving losses widen, in fact, with the lightest and most expensive carbon fiber frame structure, the majority of its frame member at its high-speed crash onto the ground also big chances of breakage, because Its texture is hard and brittle, if applied beyond the force strength beyond its load, is the result will be damaged fragmentation rather than bending deformation, and therefore, whether it is a relatively inexpensive aluminum or expensive carbon fiber frame structure, the same result would tend to appear in most of them after the ground collision.

As described above, the current implementations of multi-rotor aircraft frame, from the composition of the structure to material of the member have to be improved is necessary, aiming to achieve a specific high-performance and cost-cheap aircraft frame, this invention that is this objective, combined the stainless steel tubes and engineering plastics plates and carbon fiber rods and other materials to build the multi-rotor aircraft frame.

### SUMMARY OF THE INVENTION

Now with a 450-size quad-rotor aircraft frame example, the materials in which can be apply to the motor arm of view, the enough hardness and the malleable of stainless steel tube, when subjected to impact the result will be more tendency to bend rather than breakage, and if subjected to bend slightly, have the opportunity to correct and continue to use, which is one of the advantages of using a stainless steel tube as the arm. Compared with other materials the stainless steel tube may be relatively heavy, but its hard enough and has the toughness, so that it can be made smaller diameter and thinner wall thickness that is able to reach a considerable intensity of use, so compared with other materials whose weight does not differ much, and the smaller diameter of the tube body, the drag caused by the air will be relatively small, which is also its other advantages, therefore, in such a small lightweight multi-rotor aircraft, with relatively thin stainless steel tube as the motor arm it is quite appropriate.

This invention is the use of stainless steel chopsticks generally is use on the table, is used as a motor arm and construct a prototype multi-rotor frame, the stainless steel chopsticks are easy made, the price is cheap, which makes when required for maintenance and replacement motor arm becomes quite affordable, generally a multi-rotor aircraft within 600-class, the stainless steel chopsticks after processing can be applied directly as a motor arm to use. Secondly, engineering plastics refers to the pan with the general engineering plastics such as polypropylene (PP) Polyethylene (PE) polyacetal (POM) and nylon and other materials, these and other engineering plastics have both rigidity and toughness properties and also has some degree of impact resistance, and therefore also a suitable component material, this invention is the use of plastic cutting boards are generally used in the kitchen for the plate, as to build the basic structure members of the frame. The above materials are inexpensive and because they easily accessible, very suitable for building a usable possessed actual performance multi-rotor aircraft frame, its method is based on a stainless steel chopsticks processed as a motor arm so that the directly inserted in the plastic material main body to construct the main frame structure, and with support blocks and support rods to extending a peripheral support structure to obtain sufficient structural strength frame, thereby to build an economical and practical multi-rotor frame.

### BRIEF DESCRIPTION OF THE DRAWINGS

FIG. 1 shows the perspective view of a quad-rotor frame.

FIG. 2 is a schematic plan view of the main body of the frame.

FIG. 3 shows a cross-sectional schematic view of a tapered hole and a stepped hole.

FIG. 4 is a schematic plan view of the support block.

FIG. 5 is a schematic plan view of the motor arm.

FIG. 6 is a schematic plan view of the support rod.

FIG. 7 is a schematic plan view of the landing gear.

FIG. 8 is a schematic plan view of the square sleeve reinforcement.

FIG. 9 is a schematic plan view of a quad-rotor frame.

FIG. 10 is a presentation from a schematic plan view the distance between moving positions of the adjacent support blocks.

FIG. 11 is a perspective exploded view of a bonded main body.

FIG. 12 is a schematic perspective view of the motor mounting.

FIG. 13 is a schematic plan view of a Hex-rotor frame.

### DETAILED DESCRIPTION OF THE EMBODIMENT

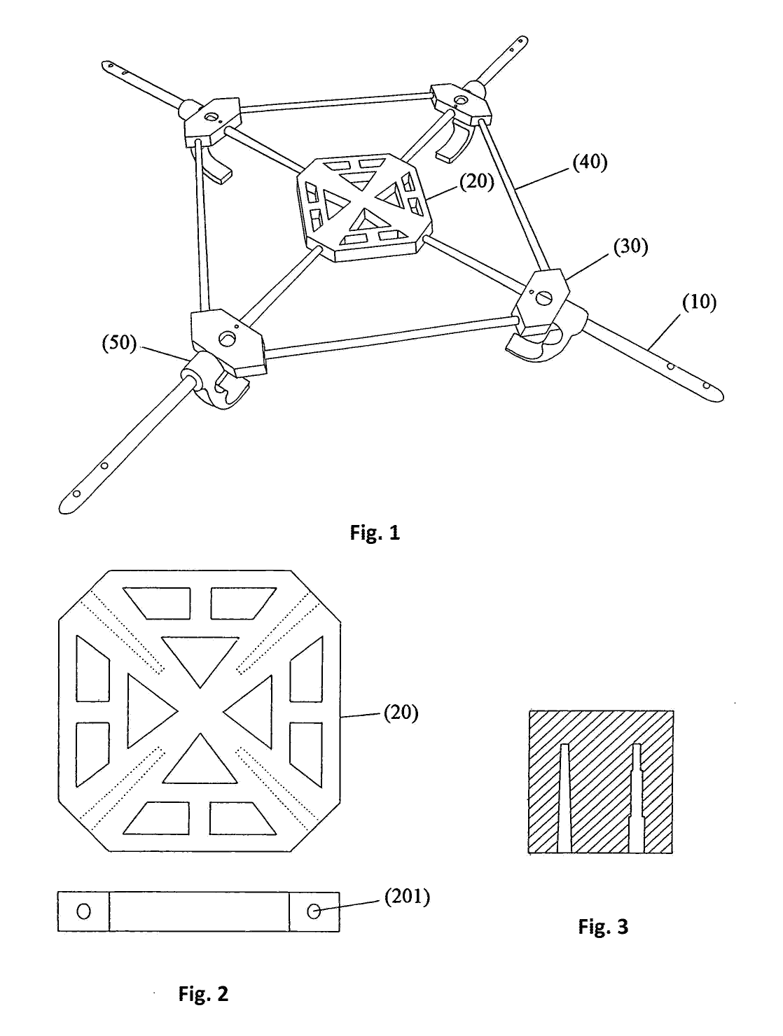

Multi-rotor frame structure, which mainly consists of a main body and a plurality of motor arms and plurality of support blocks and plurality of support rods and landing gear constitute, now with a 450-class quad-rotor frame as an embodiment example for illustration, please referring FIGS. 1 and 2, wherein the main body 20 composed of a polygon by a thick plastic material plate, in its plate body there are many empty through hole in order to reduce its weight, in the side plate body in appropriate symmetrical position has opened four arms jack-hole 201 at the depth of about 3 cm, which is for use install motor arm 10, shape and thickness of the plate are informality, its main purpose lightweight and can be symmetry inserted into the motor arms, herein, in present example a polygonal plate body, a maximum width of 8 cm, 1.1 cm thick and weighs about 40 grams, in addition, another main body structure there will be further described later.

The motor arm 10 is a stainless steel hollow metal tube at both ends of the head are all closed structure constructs (FIG. 5), its one end to the middle section forms a straight long shape, from its middle section to the other end is a smooth long tapered configuration gradually converged, thereof the long tapered end may deep as nails insert into the main body 20 arm jack-hole 201, and thereby forming the main structure of the frame; herein, the aperture of the arm jack-hole 201 on the main body 20 is slightly less than outer diameter of the long tapered end of the motor arm 10, this makes the motor arm 10 can thus deep nailed onto the plastic main body 20, the type of the arm jack-hole 201 may be tapered vs stepped deep hole (please referring to FIG. 3), in this example, a tapered hole. In addition, at a proper position of the long straight shaped end of the motor arm 10, there are two opened through-holes as motor mounting holes 101, and at an appropriate position near the middle of the tube body also opened a pore diameter of 1.5 mm of through-hole as the alignment hole 104, this alignment hole and the motor mounting hole 101 the same axial, it can be used as confirmation the support block 30 position and the motor axial upward, this embodiment uses a total four support arms.

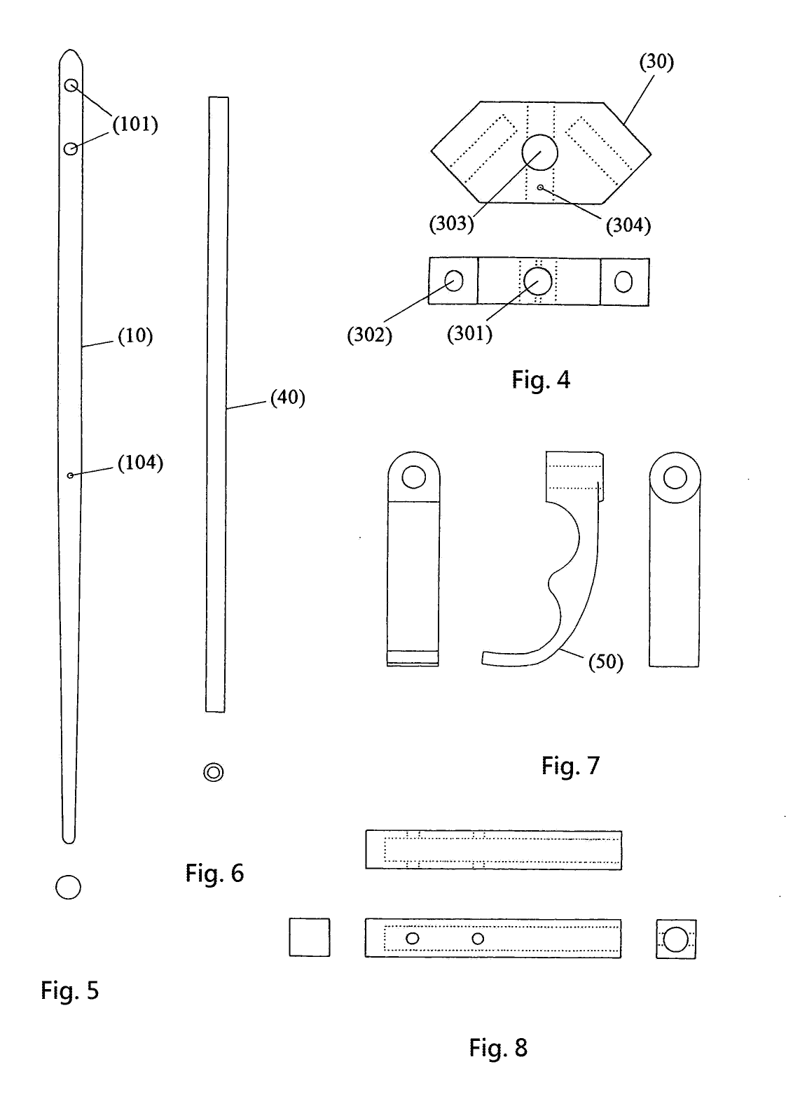

The support block 30 and the support rod 40 to build a robust system of the entire frame structure, support block 30 is a thick plastic material polygonal plate (FIG. 4), it has two long sides and four short sides, at an intermediate position of the two long sides of the plate body, there is an opening of 6 mm inner diameter of through hole as a through arm-hole 301, it is used to install the motor arm 10, and the through arm-hole 301 aperture is slightly less than the outer diameter of long straight section of the motor arm 10, so that this motor arm 10 installed the support block 30, will make the through arm-hole 301 of the support block 30 be at a sleeve-tight state. In addition, on the two short sides of the support block 30 against the main body 20, each opened a rod sleeve-hole 302 at appropriate position, these two holes were non-parallel holes, each sleeve-hole not a through hole and each approximately 18 mm depth, the axis angle between the two holes of less than 180 degrees, in the occasion of a quad-rotor frame, the angle between the axis of the two holes is about 90 degrees angle (89 degrees in this embodiment), the through arm-hole 301 axis in the middle of two rod sleeve-holes 302, is the symmetry axis of two rod sleeve-holes 302, the rod sleeve-hole 302 can put the rod 40 structure connected to each support block 30, thereby forming fastening structure of the entire frame. Support rod 40 is an appropriate length of a carbon fiber material elongated straight tube (FIG. 6), its tube body diameter and the rod sleeve-hole 302 aperture fairly, in this embodiment that both are 5 mm, making support rod 40 can freely enter and exit support block 30. In addition, the through arm-hole 301 axis department on the support block 30 plate body, at an appropriate location opened a through hole has a pore diameter of 8 mm as a stalemate hole 303 and 1.5 mm diameter of through hole as alignment hole 304, the aperture of stalemate hole 303 is greater than the maximum diameter of the motor arm 10, so that the stalemate holes 303 can thereby exposed the tube body of the motor arm, and can be hot melt adhesive or epoxy to glue the tube body and fill the hole space, it can increase the support block 30 and the motor arm 10 relative stability.

The long straight segment of the motor arm 10 can be cylindrical or square shape and other types of long straight tubular, if it is a cylindrical tube shape, the through arm-hole 301 of the support block 30 is also inevitable to be a circular hole, if it is a square tube, the through arm-hole 301 of the support block 30 also bound to be a square hole, namely, the through arm-hole 301 bore type must match to the motor arm 10 long straight segment tube type, similarly, the type of the long tapered end of the motor arm 10 may be long tapered conical or square or other types, the arm jack-hole 201 on main body 20 is also inevitable match its type of hole exists, a square motor arm tube can be better axial braking capability, in present embodiment is use one with a long straight cylindrical section and a circular conical end motor arm for illustration.

Motor arm 10 each length is about 22.5 cm, maximum tube outer diameter of about 6.5 mm or so, single weight is about 11 grams; support block 30 up to 5.2 cm length 2.4 cm width and 11 mm thickness, single weight is about 8 grams; support rod 40 a length of 17.4 cm, single weight is about 4 grams.

Landing gear 50 likewise is a plastic material member (FIG. 7), its shaped as shape of the letters J, the curved end as a ground touch section, and at the other end opened a through hole along to the ground touch section curved axial, and this through hole aperture (6 mm) is slightly smaller than the long straight section outer diameter of the motor arm 10, makes the landing gear 50 set onto the motor arm 10 will be the tight state, landing gear 50 weight is about 8 grams.

Due to engineering plastics materials have both rigidity and toughness properties, therefore the holes on plastics plate can allow a slightly larger diameter to pore size of metal tube penetrates it, and at the same time a certain degree of tight capacity and braking ability, therefore must be subjected to a considerable degree of force to make both relative displacement occur, therefore, when assembling the frame to be apply mild hand hammering or hand pressing to frame assembly, its tight degree that can be by bare hand-assembled can be an already sufficient extent, therefore, each of the ideal pore size of the aforementioned tight holes shall be in accordance with the characteristics of the chosen material and with the diameter size of the motor arm to set, to enabling smooth frame assemble and the ability to have a considerable degree of assemble stability.

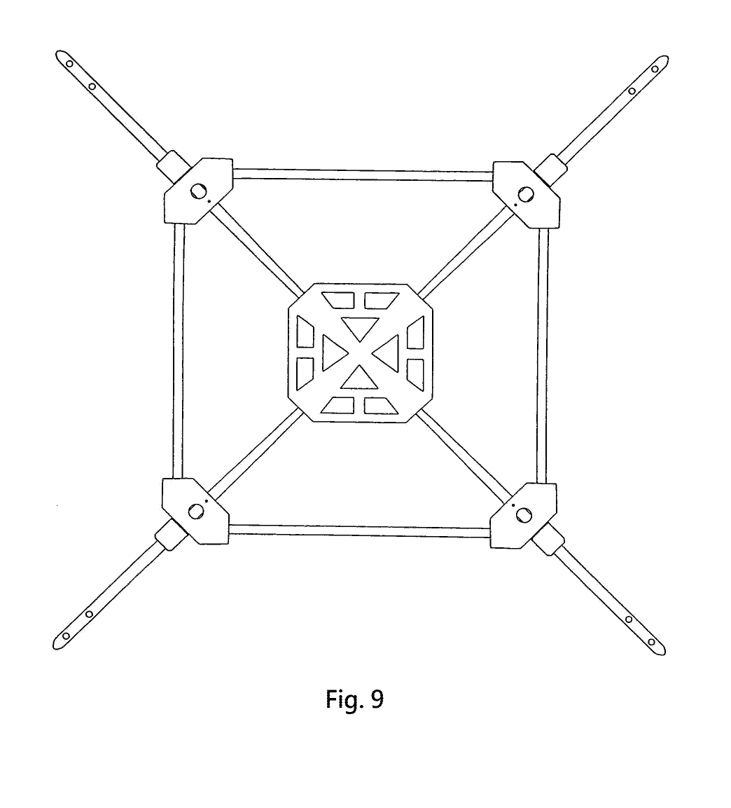

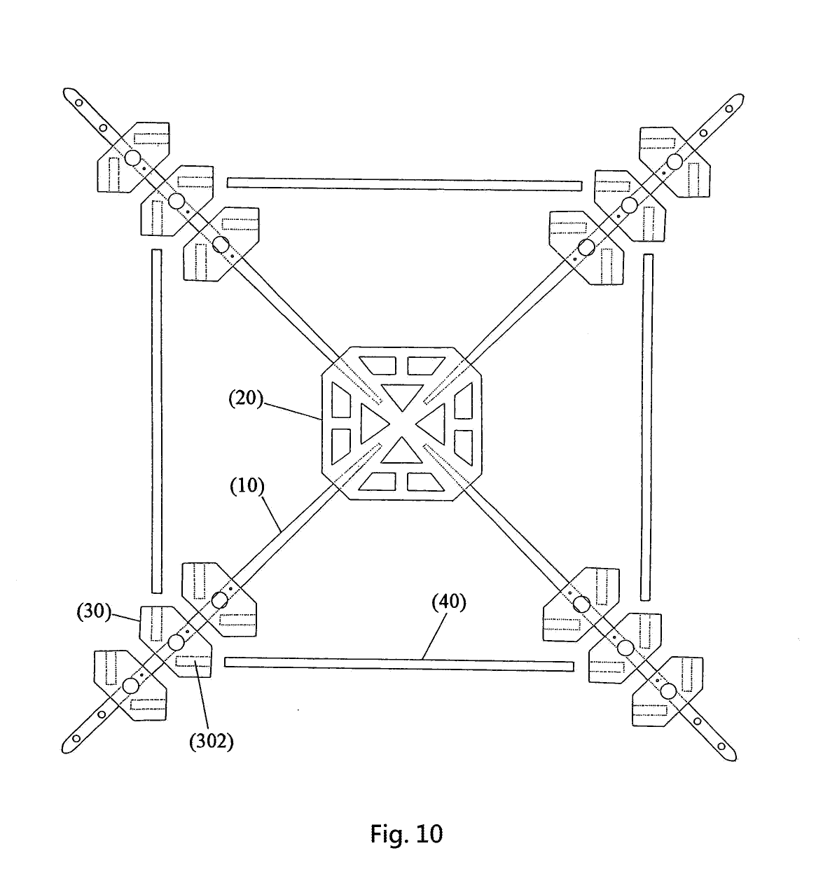

In this embodiment the quad-rotor frame comprise a main body and four motor arms and four support blocks and four support rod and four landing gears and other components (please referring to FIG. 9), in frame assembly is the first of a landing gear and a support block has fitted the motor arm (from long tapered end), then force them goes on to in place in the middle of the motor arm on straight shaped segments, and then the motor arms with long tapered end insert into the main body arm jack-hole, at this time pay attention to insert depth and adjust axial of the motor mounting hole of the motor arm upward, and then urging or forcing or pushing gently hammer the motor arms fasten to the main body, please refer to FIG. 10, if two adjacent motor arm 10 regarded as an isosceles triangle two waist, relative distance between each rod sleeve-holes 302 of the relative support blocks 30 can be considered as the bottom of the triangle, thus the movement of the two support blocks 30 to the apex of the triangle direction, to reduce its distance can support rod 40 sleeved into to construct connect the two support blocks, so, after all the four motor arms fixed, then force each support block one direction march toward main body goes to an appropriate distance, until the adjacent support blocks spacing between can be placed a support rod distance, then roughly set one support rod at both ends into each corresponding rod sleeve-hole, after four support rods are placed in position, then gradual each support block one by one move toward the main body, until each support block alignment hole 304 align the motor arm alignment hole 104 and then insert a pin (eg. a bamboo pin), thus the relative distance between each adjacent support block will be reduced meanwhile, and each ends of the four support rods and thus also further in-depth sets of holes, and due to the axis of each rod sleeve-hole of the respective adjacent support block is not aligned on the same axis line, and thus cause structural clamping effect to each rod ends, this also forms a closed structure body, locked the relative position of support block with the motor arm and the main body, all members are bound by mutual restraint and mutual support to form a solid tight frame support structure. Since the same size the outer diameter of support rod and the inner diameter of rod sleeve-hole, if two adjacent rod sleeve-hole axis that can be aligned on the same axis, the rod can freely in which to do in and out the action, but as long as a slight axis deviation exists, the sleeve-holes on two adjacent support blocks will be causing deviation angle and locked the rod activity and thus producing a clamping effect, therefore when assembling the frame must be a gradual one, sequential reduction each support blocks the distance between, gradually sleeved each rod and to make it in place, and if it need to disassemble, and vice versa.

In this case, the angle of the two rod sleeve-hole of adjacent support blocks the greater axis deviation, their restriction on two ends of the rod the extent of the greater, if so it will cause difficulties that cannot be assembled or assembled, when axis angle of two sleeve-holes of the support block is 90 degrees angle, in theoretically the two rod sleeve-hole axis of adjacent support blocks should be aligned on the same axis, but since the entire frame structure is a metal tube member by a forcing way sleeved into plastic member composition, therefore, the positional accuracy of its members is bound to be errors, and therefore the axis of the rod sleeve-holes of the two adjacent support block is not easy to actually aligned on the same axis, therefore, the each support block the two rod sleeve-holes axis can be set at about 88 degrees to 92 degrees angle, this value should be set according to the use of materials and structural components. Frame assemble completed, assuming that two opposite rod sleeve-holes of the hole bottom relative distance of 18 cm, the length of the rod can be set to 17.4 cm, so that after the rod sleeve into the hole, may remain in their head ends about 3-5 mm sleeve-hole end space to use as a buffer space, the rod at each end sleeved into the hole to about 8 mm when that is the effect of having a good structure.

Another way is to first assemble the landing gear and the support block to the motor arm, and the support block alignment hole aligned to the alignment hole of the motor arm and insert a pin, and in the unilateral of each support block insert one support rod, and then each motor arms insert into the arm jack-hole of the main body respectively, along with each motor arm insertion depth increases, it will also enable the relative distance between the adjacent support blocks and thus also consequent reduction, this makes the other end of the rod can sleeved into the adjacent support block, then each motor arm one by one sequential gradually deep into place to complete the assembly work.

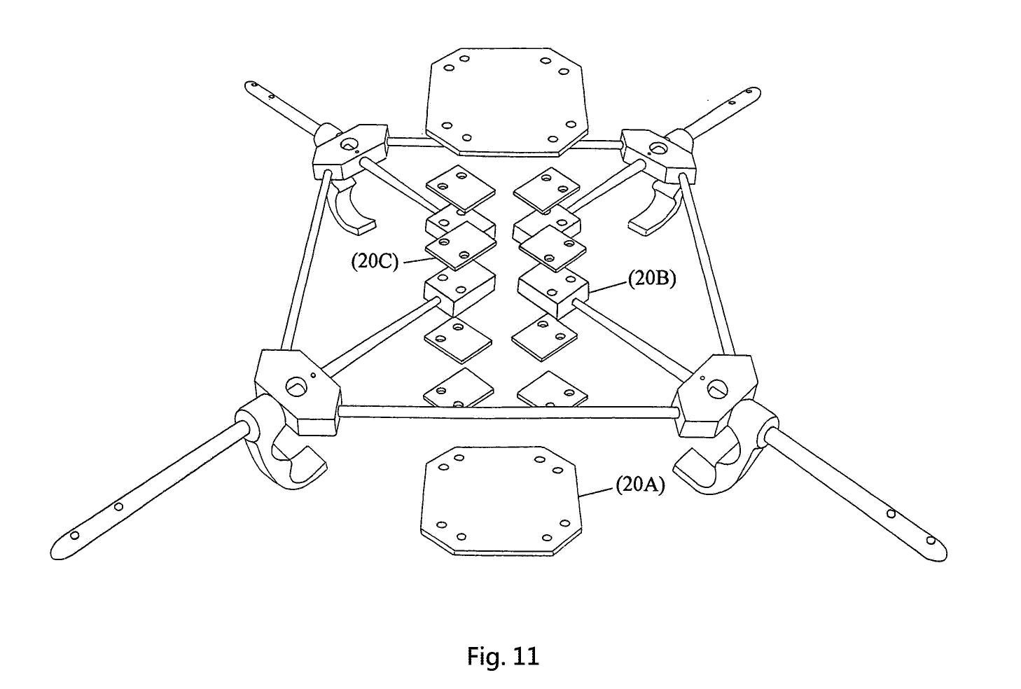

FIG. 11, is another form of main body constitution, a sandwiches style structure main body of the frame, the main body is mainly composed of the upper and lower fiberboard 20A and four plastic motor arm seat 20B constituted, in the motor arm seat 20B is set has an arm jack-hole for installing the motor arm, the upper and lower two fibreboard 20A bonding each motor arm seat 20B by double-sided adhesive tapes 20C, at appropriate position for each of the bonding departments, are set has two through holes as engaging positioning holes, which can accommodate screw penetration to facilitate mounting work with. Frame assemble methods first set the landing gear and the support block to the motor arm and the motor arm inserted into the arm jack-hole of each motor arm seat respectively, each motor arm seat then engaged with the upper and lower piece of fiberboard, and set two screws into the positioning holes to confirm the correct engagement position, thereafter lock the screws roughly, thereafter can install the support rod, etc. to complete the assembly operation, after complete assembled remove the positioning screws. Double-sided tape is the thickness of about 1 mm, at the time when the rotor out of control hit to the ground it may have some degree of shock absorption cushioning effect and may form a soft protective effect to the main body, two sheets of fiberboard can shape all kinds of appropriate shape empty holes, to reduce its weight.

In addition, the diameter of the motor mounting hole of the motor arm is 3 mm, directly to two 3 mm screws locking the motor, in 3 mm screws to secure the motor in the present example in flying test is equipped with A2212 and A2217 1000 KV-1400 KV motors and other kinds of motors, and propeller, respectively, with 8045 or 9038 or 1045 and other kinds of positive and negative propeller, and 30 A-40 A the E S C and 11.1 v 2250 mah lithium polymer batteries, take off weight is between 880-1000 grams, in after several flight tests and demonstrate a variety of flight maneuvers, for example after the flip somersaults and rolls and high-speed rotation and other aerial movements, it confirmed the fastened state of the motors and a solid frame structure performance. However, to install a larger series of motors, for example, 4 mm screws locking the motor, the motor mounting hole aperture also 4 mm, so the motor mounting position of the motor arm can install a reinforcement square sleeve (please referring to FIG. 8), the square sleeve is also a plastics material sleeve, its tube inner diameter approximate the outer diameter of the motor arm can smooth sleeved thereon for motor mounts use, in the present example this square sleeve can also be used as a reinforce structure on the motor mounting portion of the motor arm, the weight of the square sleeve is about 7 grams.

Above is the main constituent structure and assembly methods of the multi-rotor frame embodiment of present invention, the frame assemble without the use of screws, can have close structural strength sufficient to meet the various needs of flight actions structural strength, and when the multi-rotor uncontrolled to hit to the ground is allowing the loss to a minimum, this because the frame body fell to the ground in shock when the arm is supported by solid support blocks and rods posed protective structure will become the periphery protection, so the impact will be largely limited to the motor arms body, the main structure of the frame might distort deformed, but because of the plastic material members has a toughness stamina, therefore destruction of the small chance, therefore at the high speed impact the ground circumstances, about just swap the damaged the motor arm and to adjust correction the structure of the frame, the repair operations can be completed (propeller except). Since none of the components of the frame assemble with screws fastening, entire frame after completion assembly were not a rigid structure, but is fairly similar to a considerable structural strength flexible structure, therefore when suffered external shocks is more to withstand the impact the flexible space.

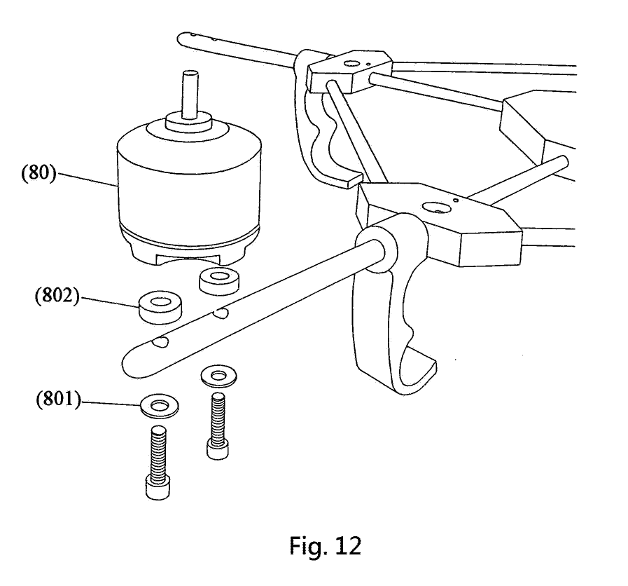

Since the ends of the motor arms are all closed structured, therefore its ends are all with considerable strength, and therefore the motor can be directly screw locking to the motor arm, (please referring to FIG. 12) to screws first put a metal gasket 801 and plastic spacers 802 thereafter lock the motor 80, screw locking tightness may be sufficient to meet the needs of the fixed motor, and screws lock together with the thread glue can prevent the occurrence of loosening, and finally, in the arm on the support block 30 stalemate hole 303 inject hot melt adhesive, also the melt adhesive coating can be apply to the outside of the support block of the motor arm tube body, then landing gear to push to the support block to bonding, so can even more to increase the stability of the motor arm also make it more difficult to emerge axial rotation (the positioning pin remove or not can be). The frame itself is a basic platform structure, in the present example, a very light weight of about 165 grams of the 450-size quad-rotor, which makes the frame can without affecting the flight performance status to have more equipment carrying capacity, so is a both practical and economical, high-performance multirotor frame.

In the present invention, in many actual flight test, in the case of unintentionally allow the aircraft to ground collision at high speed, that is, found the out of control aircraft about to plunging to the ground the situation, immediately shutting power (the basic steps), along with the aircraft crashed into the ground posture and the impact of the collision of different intensity, for damage caused to the motor arm, there is the case from a slight distortion or distorted by the motor mounting holes or bent or the distorted at the support block edges, or cause deformation of the frame structure to the support rod one end detached situation occur, however, the damage is limited to the circumstances of the motor arms, the other members of the frame are no damage occurred, so adjust the frame structure or swap the motor arm after can be fly again (the motors and electronic equipment no damage record, propeller excepted). When servicing swap the motor arm, to single-hand holding the support block and rod of the damaged motor arm, the other hand held clamp to live the motor arm and slightly axial rotating to extract, the arm can be pull out from the main body, next, the new motor arm plug back in, screw lock the motor and check the axial direction of the motors corrected, then adjust the correct frame structure and recognized as normal, and with a hot melt glue gun can repair all the need to re-glue places to complete the repair job of the frame.

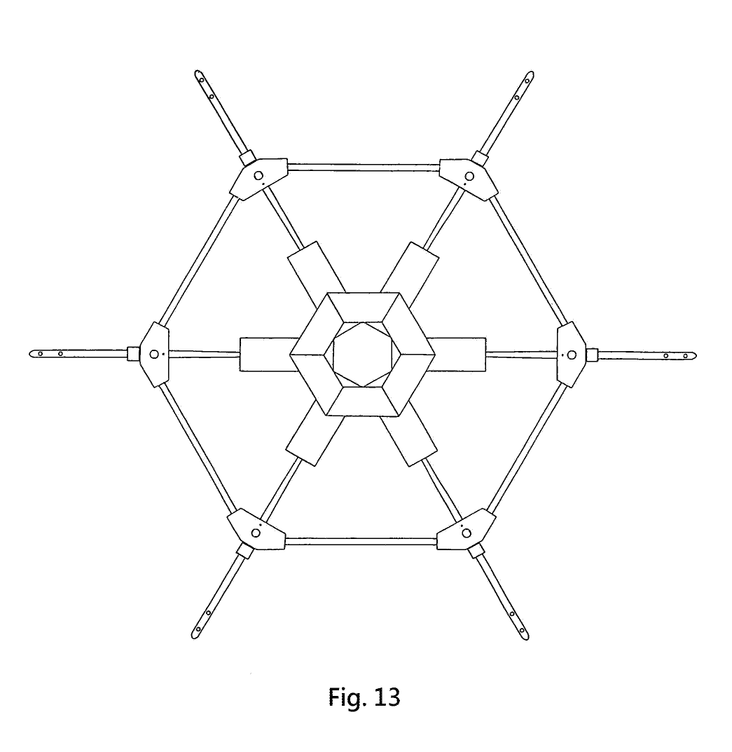

The above is constitute the concept and method of construction of the invention of the multi-rotor frame, according to the manner described above of the frame structure and construction methods, a Hex-rotor frame can also be constructed to completed (FIG. 13), the frame size is about 580 mm, the difference to Quad-rotor frame structure is only in different configurations of the main body, and the angle between two axis of the rod sleeve-hole at both sides of the support block is about 120 degrees, nor limit the shapes of the main member, mainly in the light-weight and nice shapes and able to construct a solid frame structure will be an appropriate component modeling, this tight structure under the concept of invention, frame member may also use other materials to manufacture, for example an aluminum materials main body and support block, thus, all the tighten nature holes, the arm jack-holes of main body the rod sleeve-holes of support block, they can be set up to have a plastics bushing in order to achieve the required tight effect, and so the concept of the model to enlarge the size of all the members, a larger size multi-rotor frame can be constructed, to achieve the aim to construct a practical low cost, and low maintenance costs, high-performance aircraft frame, and an innovative with high efficiency design.

While the embodiment of the invention have been set forth for the purpose of disclosure, modifications of the disclosed embodiment of the invention as well as other embodiment thereof may occur to those skilled in the art. The scope of the claims should not be limited by the embodiment set forth in the examples, but should be given the broadest interpretation consistent with the description as a whole.

What is claimed is:

1. A multi-rotor frame structure, comprising a main body and a plurality of motor arms and a plurality of support blocks and a plurality of support rods and landing gears and other components, wherein, the main body has two different structure configurations:
one is a thick plastic plate, thereon with a plurality of arm jack-holes each located at each symmetrical sides positions, and
the other one is an composition of a plurality of motor arm seats and two sheets of fiberboard, each seat has an arm jack-hole, each seat combine to two fiberboard by double-sided tapes, two sheets of fiberboard bonded sandwiched each motor arm seat at symmetrical position, each arm jack-hole location symmetry, it is for motor arm insert purposes;
the motor arm is a hollow metal tube at both ends of the head are all closed structure constructs, its one end to the middle section forms a straight long shape, from its middle section to the other end is a smooth long tapered configuration gradually converge, thereof the long tapered end may be deep as nails insert into arm jack-hole of the main body, and thereby forming the main structure of the frame;
the support block is a thick plastic plate, wherein in the middle portion of the sides of the plate has a through arm-hole which can put on to the motor arm, and
wherein two rod sleeve-holes are located in the left and right sides of the plate be able to install support rod, thereafter the support rods sleeved to the respective adjacent support block thereof to constitute securing structure of the frame.

2. The multi-rotor frame structure as claim 1, wherein the outer diameter of the tapered end of the motor arm is slightly larger than the arm jack-hole aperture of the main body, so that the arm jack-hole become to a tighten nature hole, that makes motor arm may tightly inserted into the main body, and the outer diameter of the long straight section of the motor arm is slightly larger to the aperture of the through arm-hole of the support block, so that the through arm-hole become to a tighten nature hole, thereby the support block to firmly sleeved on the long straight section of the motor arm.

3. The multi-rotor frame structure as claim 1, wherein, the two rod sleeve-holes of the support block were non-parallel holes, and wherein, the pore size of the two rod sleeve-holes equals to the outer diameter of the support rod, and wherein, the axis of the through arm-hole among the two rod sleeve-holes is the symmetry axis of the two rod sleeve-holes, and wherein, in the department of the axis of the through arm-hole of the support block plate opened a stalemate hole at proper position, which pore size greater than the largest arm outer diameter of the motor arm.
